(19) United States
(12) Patent Application Publication
(10) Pub. No.: US 2010/0253754 A1
(43) Pub. Date: Oct. 7, 2010

(54) INK CARTRIDGE, ESPECIALLY FOR AN INK JET PRINTER

(75) Inventors: Daniel Sulser, Wald (CH); René Butty, Hinwil (CH)

Correspondence Address: MICHAEL BEST & FRIEDRICH LLP, 100 E WISCONSIN AVENUE, Suite 3300, MILWAUKEE, WI, 53202, US

(73) Assignee: PELIKAN HARDCOPY PRODUCTION AG, Egg (CH)

(21) Appl. No.: 12/743,749

(22) PCT Filed: Nov. 18, 2008
(86) PCT No.: PCT/EP08/65725

§ 371 Date: May 19, 2010

(30) Foreign Application Priority Data
Nov. 19, 2007 (DE) 102007055162.4

(51) Int. Cl. B41J 2/175; B41J 2/19

(52) U.S. Cl. 347/86; 347/92

(57) ABSTRACT

An ink cartridge (10) having an ink reservoir which delimits in a first chamber (17) a free-ink volume (16) and in a second chamber (18) a capillary volume (15), the two chambers (17, 18) being in fluidic connection with one another, and there being an ink outlet (21) associated with the chamber (18) delimiting the capillary volume (15). A bubble generator is provided in the form of a dip tube (29) which dips into the free-ink volume (16) and is connectible to the external environment and at the distal end of which there is formed at least one opening (30) for the introduction of air bubbles.

### RELATED APPLICATION DATA

This application claims priority from German Patent Application No. 102007055162.4, filed Nov. 19, 2007 and PCT Application No. PCT/EP2008/065725, filed Nov. 18, 2008, both of which are incorporated by reference herein.

### BACKGROUND

The invention relates to an ink cartridge, especially for an inkjet printer, having an ink reservoir which delimits in a first chamber a free-ink volume and in a second chamber a capillary volume, the two chambers being in fluidic connection with one another, and there being an ink outlet associated with the chamber delimiting the capillary volume.

So-called two-chamber ink cartridges of that kind are generally known, one chamber predominantly being filled with liquid ink and the other with an ink storage element defining a capillary volume, for example made of sponge material or fibre material, the objective being to achieve controlled emptying of the two chambers when the ink cartridge is being used, for example, in an inkjet printer. Conventionally the amount withdrawn from the two chambers is approximately the same. At the beginning, about ¼ of the amount of ink withdrawn is withdrawn from the capillary volume. There then follows the withdrawal of approximately ½ of the total amount from the ink chamber, i.e. from the chamber delimiting the free-ink volume. Finally, a further ¼ of the total amount is withdrawn from the capillary volume.

### SUMMARY

As a rule, the admission of air and therefore pressure compensation take place through the capillary volume. Once the capillary volume is about half empty, the lowered filling level unblocks an opening for admitting air into the chamber delimiting the free-ink volume. In that way, air can then be admitted to the latter chamber through the storage element, i.e. the capillary volume. A disadvantage is that two different storage materials are necessary for the capillary volume, those materials being a first storage material for the upper region having large pores, which is emptied first, and a second storage material for the lower region of the cartridge close to the ink outlet having smaller pores. Only by virtue of that arrangement is it possible reliably to effect the admission of air to the two chambers of the ink cartridge.

It should also be pointed out that the two chambers are in fluidic connection, this being effected by way of a passageway, arranged close to the base, in an intermediate wall by means of which the two chambers are separated from one another inside the ink cartridge.

The present invention is based on the problem of providing an ink cartridge in which it is possible to use a single storage material for defining the capillary volume, that is to say a storage material of a uniform pore size. A further objective is to facilitate pressure equalization by its not having to be take place via the capillary volume.

According to the invention, air is admitted to the free-ink chamber, there additionally being provided separate admission of air to the capillary volume, i.e. to the chamber delimiting the capillary volume. The admission of air to the chamber delimiting the free-ink volume is effected according to the invention through a dip tube which starts from the top wall of the cartridge and has one or more very small, preferably slot-like, openings at its submerged distal end. By means of the size of those openings it is possible to control the withdrawal timepoint or so-called “bubble point” of the chamber delimiting the free-ink volume.

Compared with a hole-like opening, a slot-like opening also has the advantage that it is much less sensitive to dirt particles and is accordingly more efficient in respect of the amount of air flowing through.

By virtue of the bubble generator according to the invention in the form of a dip tube it is ensured that the admission of air to the two chambers and, accordingly, also the emptying thereof is controlled by the construction of the bubble generator and not by the capillary volume, i.e. by the material defining the capillary volume. The capillary volume is formed by a uniform material of constant pore size.

In that respect the solution according to the invention is distinguished by a construction that is simpler and accordingly more economical and, in respect of the emptying of the ink cartridge, particularly reliable in operation.

Furthermore, it should be pointed out that it is advantageous for the dip tube defining the bubble generator to extend to a point close to the base wall of the ink cartridge, at least approximately to the level of the fluidic connection between the two chambers.

With separate admission of air to the two chambers it should also be pointed out that this is effected in each case by way of the top wall of the cartridge. Preferably, the air-admission openings provided therein are arranged one inside the other, so that an inner opening and an outer opening surrounding the inner opening in the shape of a ring are formed.

The latter is connected to the chamber delimiting the capillary volume by way of at least one air channel formed in the top wall, while the inner central opening is connected to the bubble generator, i.e. the dip tube defining the bubble generator, by way of a further air channel formed in the top wall.

A preferred embodiment of an ink cartridge constructed in accordance with the invention is described in greater detail below with reference to the accompanying drawing.

### BRIEF DESCRIPTION OF THE DRAWINGS

FIG. 1 shows an ink cartridge constructed in accordance with the invention in a perspective view, obliquely from above, the front side wall being cut away to show the bubble generator according to the invention;

FIG. 2 is a view corresponding to FIG. 1, but obliquely from below;

FIG. 3 shows the detail III in FIG. 2 on an enlarged scale;

FIG. 4 is a perspective view of the ink cartridge according to FIG. 1 and FIG. 2 prior to use; and

FIG. 5 shows the ink cartridge according to FIG. 4 in longitudinal section.

### DETAILED DESCRIPTION

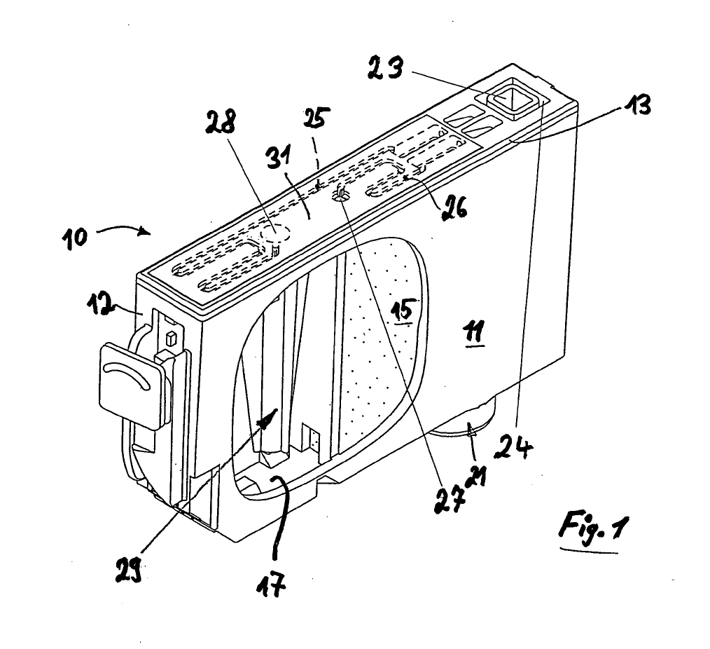

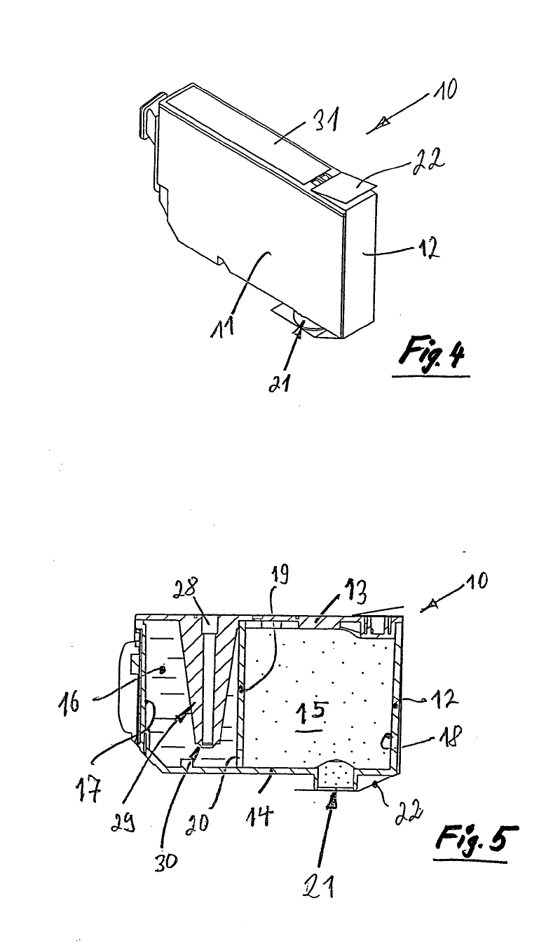

The ink cartridge shown in FIGS. 1, 2 and 4, 5 is indicated by reference numeral 10. It comprises four side walls, more specifically two flat side walls 11 located opposite one another and two end side walls 12 located opposite one another, as well as a top wall 13 and a base wall 14. Inside the cartridge 10 there are formed two chambers, namely a first chamber 17, which delimits a so-called free-ink volume 16, and a second chamber 18, which delimits a so-called capillary volume 15. That capillary volume 15 is defined by an ink storage element in the form of an open-pored sponge or fiber material. An ink outlet 21 is associated with the storage element, i.e. the capillary volume 15, at the base thereof. The two chambers are separated from one another inside the cartridge by a partition wall 19. At the base the partition wall 19 has a fluid passageway 20 between the two chambers 17 and 18. The top wall 13 is in the form of a separate component and comprises two air-admission openings 23, 24 which are arranged one inside the other. An inner air-admission opening 23 is surrounded in a ring shape by an outer air-admission opening 24. The inner air-admission opening is in fluidic connection with the first chamber 17, which delimits the free-ink volume 16, by way of an air channel 25 formed in the top wall 13, while the outer air-admission opening 24 is connected to the second chamber 18, which delimits the capillary volume 15, by way of a separate air channel 26 likewise formed in the top wall 13. The latter channel leads into the second chamber 18 by way of an opening 27 in the underside of the top wall 13.

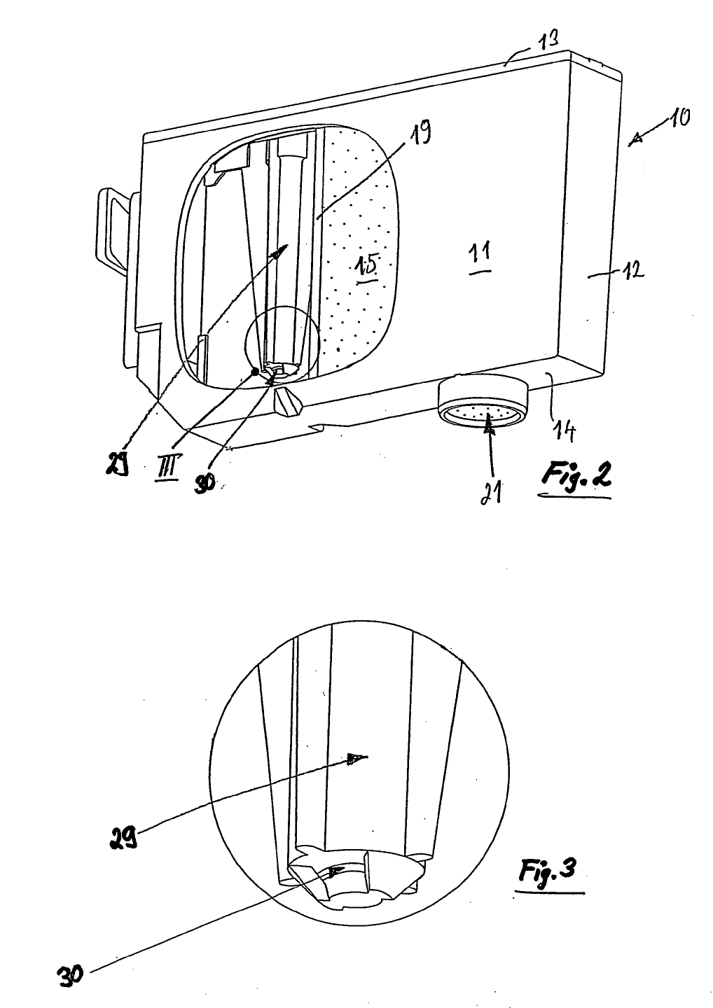

The first air channel 25 also leads into the first chamber 17 by way of an opening 28 in the underside of the top wall 13, not directly but by way of a dip tube 29 in the form of a bubble generator. The dip tube therefore extends from the underside of the top wall 13 downwards into the first chamber 17 delimiting the free-ink volume 16. At the distal end of the dip tube 29 there is formed at least one opening 30 for the introduction of air bubbles into the free-ink. In the embodiment shown, that opening specifically comprises two slot openings arranged diametrically with respect to one another relative to the longitudinal axis of the tube, of which only one slot opening can be seen in each of FIGS. 2 and 3. The size of those slot openings 30 at the distal end of the dip tube 29 is in each case such that, when the ink cartridge is in use, only once about ¼ of the capillary volume has been used, the ink draws air through that opening 30 into the free-ink volume, forming fine bubbles. The bubble generator so formed defines a capillary pressure which is preferably lower than the capillary pressure at the ink outlet 21 but higher than the capillary pressure in the capillary volume 15. It should also be pointed out here that the capillary pressure at the ink outlet is defined by a wick made of foam or fibrous material arranged inside the ink outlet. The wick has a higher density and thus a smaller pore size than the storage material defining the capillary volume 15.

Specifically, the slot-like openings 30 at the distal end of the dip tube 29 are adjusted so that the capillary pressure of the bubble generator is up to a maximum of about 150 percent, especially between about 50 percent and 150 percent, greater than the capillary pressure when the capillary volume 15 is full.

A common remove film 22 is associated with the two air-admission openings 23, 24 on the one hand and the ink outlet 21 on the other hand. The remove film is peeled off prior to use of the cartridge 10, it always being ensured, by virtue of the above-described construction of the two air-admission openings 23, 24, that air is admitted first to the chamber 18 delimiting the capillary volume and only then to the chamber 17 delimiting the free-ink volume. In that way, ink is prevented from splashing unintentionally out of the air-admission opening 23 connected to the first chamber 17 when the pressure is equalized.

The two afore-mentioned air channels 25, 26 are formed, especially by milling, on the upper side of the top wall 13. They are closed by a cover film 31.

On the side wall located opposite the end side wall 12 over which the remove film 22 extends there are also provided measures for fixing the ink cartridge 10 inside a seating of the inkjet printer, such measures being measures known per se which need not be described in detail herein.

All the features disclosed in the application documents are claimed as being important to the invention to the extent that they are novel individually or in combination with respect to the prior art.

1-6. (canceled)

7. An ink cartridge configured for use with an inkjet printer, the ink cartridge comprising:
an ink reservoir which delimits in a first chamber (17) a free-ink volume (16) and in a second chamber (18) a capillary volume (15), the two chambers (17, 18) being in fluidic connection with one another;
an ink outlet (21) associated with the chamber (18) delimiting the capillary volume (15); and
a bubble generator in the form of a dip tube (29) which dips into the free-ink volume (16) and is connectible to an external environment and at a distal end of the dip tube there is formed at least one opening (30) for the introduction of air bubbles.

8. The ink cartridge according to claim 7, wherein the at least one opening (30) at the distal end of the dip tube (29) is a slot opening.

9. The ink cartridge according to claim 8, wherein at the distal end of the dip tube (29) there are formed at least two slot openings (30) arranged diametrically with respect to one another relative to a longitudinal axis of the dip tube.

10. The ink cartridge according to claim 7, wherein the size of the at least one opening (30) at the distal end of the dip tube (29) is such that, when the ink cartridge (10) is in use, only once about one-fourth of the capillary volume has been used, the ink draws air through the at least one opening (30) into the free-ink volume, forming fine bubbles.

11. The ink cartridge according to claim 8, wherein the size of the at least one opening (30) at the distal end of the dip tube (29) is such that, when the ink cartridge (10) is in use, only once about one-fourth of the capillary volume has been used, the ink draws air through the at least one opening (30) into the free-ink volume, forming fine bubbles.

12. The ink cartridge according to claim 9, wherein the size of the at least one opening (30) at the distal end of the dip tube (29) is such that, when the ink cartridge (10) is in use, only once about one-fourth of the capillary volume has been used, the ink draws air through the at least one opening (30) into the free-ink volume, forming fine bubbles.

13. The ink cartridge according to claim 7, wherein the bubble generator defines a capillary pressure which is lower than the capillary pressure at the ink outlet (21) but higher than the capillary pressure in the capillary volume (15).

14. The ink cartridge according to claim 8, wherein the bubble generator defines a capillary pressure which is lower than the capillary pressure at the ink outlet (21) but higher than the capillary pressure in the capillary volume (15).

15. The ink cartridge according to claim 9, wherein the bubble generator defines a capillary pressure which is lower than the capillary pressure at the ink outlet (21) but higher than the capillary pressure in the capillary volume (15).

16. The ink cartridge according to claim 10, wherein the bubble generator defines a capillary pressure which is lower than the capillary pressure at the ink outlet (21) but higher than the capillary pressure in the capillary volume (15).

17. The ink cartridge according to claim 13, wherein the capillary pressure of the bubble generator is up to a maximum of about 150 percent greater than the capillary pressure when the capillary volume (15) is full.
